(19) United States
(12) Patent Application Publication
(10) Pub. No.: US 2010/0218088 A1
(43) Pub. Date: Aug. 26, 2010

(54) STRUCTURED DOCUMENT CONVERTING DEVICE

(76) Inventor: Keiichi Iguchi, Tokyo (JP)

Correspondence Address: Mr. Jackson Chen, 6535 N. STATE HWY 161, IRVING, TX, 75039, US

(21) Appl. No.: 12/602,233

(22) PCT Filed: May 26, 2008
(86) PCT No.: PCT/JP2008/059643

§ 371 Date: Nov. 30, 2009

(30) Foreign Application Priority Data
May 28, 2007 (JP) 2007-139934

(51) Int. Cl. G06F 17/00

(52) U.S. Cl. 715/239

(57) ABSTRACT

The structured document converting device comprises a conversion rule analyzing section for analyzing a conversion rule and creating a state transition rule representing the state transition condition and an element extraction method and an output template used as the template of an output structured document. A state transition section extracts information needed to be applied to an output structured document as difference information associated with an output portion according to the result of sequential analysis during the state transition conforming to the state transition rule. A difference applying section sequentially reads the output template according to the instruction of the state transition section, immediately applies the extracted difference information if the difference information is an element to be outputted next, stores it temporarily if not, and implements sequential output until information created as a part of the output structured document cannot be acquired.

### FIELD OF THE INVENTION

The present invention relates to a structured document converting device, a structured document conversion method and a program.

### BACKGROUND ART

An example of a structured document device enabling a sequential analysis is described in Patent document 1 and Patent document 2.

For example, a conversion method applied to a structured document converting device described in Patent document 1 generates, based on template information showing a correspondence of all tags in a converted structured document and an end tag in a structured document to be converted and search table information to retrieve an corresponding element name of the converted structured document with an element name of a structured object to be converted as a key, a reverse lookup table information in which all tags in the converted structured document, the end tag in the structured document to be converted, and a value of its element are associated with each other in the tag placement order of the converted structured document, respectively. And, based on this reverse lookup table information, a converted structured document corresponding to the structured document to be converted is generated by applying an element value of the corresponding tag of the structured document to be converted in the tag placement order of the converted structured document.

Also, in a conversion method applied to a data converting device described in Patent document 2, a number of the dimensions of a data storing sequence for storing an end element data value of pre-converted data is determined based on a structural pattern that expresses a structure of the pre-converted data as a combination of a basic structural pattern and a tag structure, and the end element data value is stored to the data storing sequence. And, the end element data value of the pre-converted data stored in the data storing sequence is processed according to a conversion command to be outputted as converted data.

Further, another structured document conversion method is shown in Non-patent document 1. By a structured document conversion method described in Non-patent document 1, a sequential analysis is performed to a structured document, and the result is outputted while converting is performed sequentially according to a conversion rule. Note that, information that should be outputted in order different from a pre-converted document order is buffered according to the conversion rule.

Patent document 1: Japanese Patent Laid-Open No. 2006-11549
Patent document 1: Japanese Patent Laid-Open No. 2006-163820
Non-patent document 1: Oliver Bavker, “STX-Transforming XML on the Fly-How STX Enables the Processing of Large documents”, [online], XML Europe 2003, London, [searched in Apr. 20, 2007], Internet, <URL: http://www.idealliance.org/papers/xmle03/slides/baeker/index.html>

### DISCLOSURE OF THE INVENTION

### Problem to be Solved by the Invention

The first problem is that it is necessary to accumulate all output contents in the conversion method shown in Patent document 1 or Patent document 2, therefore a large memory area is required for a computer. The reason is because an element order of an input document is sometimes different from that of an output document, and it cannot be determined whether all output elements are prepared unless all elements of the input document are completed.

The second problem is that, in the conversion method disclosed in Patent document 1, when an element order of an input document is different from that of an output document, it is necessary to describe a buffering method in a conversion rule, and this makes the description of the conversion rule complicated. The reason is because the input document is processed sequentially, therefore an element lacking a buffering instruction in the conversion rule cannot be used later.

The third problem is that a conversion rule described by an XSLT (eXtensible Stylesheet Language Tree construction) that is a standard specification cannot be processed by the conversion method shown in Patent document 1, Patent document 2 or Non-patent document 1. As for the reason, in the conversion method described in Patent documents 1 or 2, an output document schema (structure information such as definitions of the tag) is necessary as an input, however, the output document schema is not defined in the XSLT. Further, in the method shown in Non-patent document 1, when an element order of an input document is different from that of an output document, it is necessary to describe a buffering method in a conversion rule. However, a conversion having a different order is indicated without describing a definition' about the order in the XSLT.

Thus, an exemplary object of the present invention is to provide a structured document converting device, a structured document conversion method and a program that can convert a structured document by sequential processing not always requiring a memory area enough for storing all output documents or a memory area enough for reading all input documents.

Also, an exemplary object of the present invention is to convert a structured document by sequential processing without describing information about an order in a conversion rule even when an element appearance order of an input document is different from that of an output document, i.e., even when an appearance order of the same element is different in a structured form before the conversion and a structured form after the conversion.

Further, an exemplary object of the present invention is to convert a structured document by sequential processing according to a conversion rule described in the XSLT.

### Means to Solve the Problem

A structured document converting device according to an exemplary aspect of the invention is a structured document converting device for converting a document structure of a structured document, comprising: a conversion rule analyzing section that generates a state transition rule that establishes analysis information of a sequential analysis result to an input structured document as an event to each state associating with a template of a converted structured document and a document structure of a pre-converted structured document according to a predetermined conversion rule, the state transition rule establishes a state of destination and information that is extracted as predetermined difference information to be applied to the template; a state transition section that transits a state and extracts difference information 0 or more that should be extracted according to the state transition rule generated by the conversion rule analyzing section when receiving the analysis information showing the sequential analysis result to the pre-converted structured document; a difference information storage section that accumulates difference information; and a difference applying section that sequentially outputs information formed as a part of the converted structured document to the template by applying the difference information extracted by the state transition section or the difference information accumulated in the difference information storage section, wherein the difference applying section applies and outputs the difference information extracted by the state transition section when the difference information is applicable to a template immediately, and if not accumulates the difference information in the difference information storage section and waits for next difference information extraction.

The conversion rule analyzing section may divide the converted structured document every part structure to be grouped as an output unit and generate a template when the output unit forms a group, the conversion rule analyzing section may generate a state transition rule that establishes that when the state transits to a state corresponding to a first element of a part structure to be grouped as an output unit, the template corresponding to the part structure is output; and the state transition section may specify a template to be outputted according to the state transition rule.

The structured document converting device may comprise an output interruption point storage section that stores a point where the difference applying section interrupts an output and information showing difference information applied to the point, wherein the difference applying section may interrupt a sequential output and store the interruption point and the information showing the difference information that should be applied to the point in the output interruption point storage section when the information formed as a part of the converted structured document cannot be obtained even if the difference information accumulated in the difference information storage section is applied to the template during the sequential output, and the difference applying section may determine whether the difference information can be applied to the template immediately based on an identifier of the difference information extracted by the state transition section and the information showing the difference information stored in the output interruption point storage section.

The conversion rule analyzing section may generate a state transition rule that establishes a condition for identifying an extraction end of difference information, the state transition section may detect the extraction end of the difference information according to the state transition rule, and the difference applying section may restart the sequential output when the extraction end of the difference information that should be applied to the interruption point of the current output is detected by the state transition section.

The conversion rule analyzing section may generate a state transition rule that establishes a condition for identifying an extraction end of difference information based on the maximum appearance number of times of element or the appearance order of element shown as a rule of the document structure of the pre-converted structured document.

A structured document converting method according to an exemplary aspect of the invention is a structured document converting method for converting a document structure of a structured document, the method: generates a state transition rule that establishes analysis information of a sequential analysis result to an input structured document as an event to each state associating with a template of a converted structured document and a document structure of a pre-converted structured document according to a predetermined conversion rule, the state transition rule establishes a state of destination and information that is extracted as predetermined difference information to be applied to the template; transits a state and extracts difference information 0 or more that should be extracted according to the state transition rule generated by a conversion rule analyzing section when receiving the analysis information showing the sequential analysis result to the pre-converted structured document; and in a course of outputting information formed as a part of the converted structured document to the template by applying the difference information extracted by a state transition section or difference information accumulated in a predetermined difference information storage section, the method applies and outputs the extracted difference information when the difference information is applicable to a template immediately, and if not accumulates the difference information in the difference information storage section and waits for next difference information extraction.

The structured document converting method may divide the converted structured document every part structure to be grouped as an output unit and generate a template when the output unit forms a group and generates a state transition rule that establishes that when the state transits to a state corresponding to a first element of a part structure to be grouped as an output unit, the template corresponding to the part structure is output, and specify a template to be outputted accompanying the state transition according to the state transition rule.

The structured document converting method may interrupt a sequential output and store an interruption point and information showing difference information that should be applied to the point in a predetermined output interruption point storage section when the information formed as a part of the converted structured document cannot be obtained even if the difference information accumulated in the difference information storage section is applied to the template and when the difference information is extracted, the method may determine whether the difference information can be applied to the template immediately based on an identifier of the extracted difference information and the information showing the difference information stored in the output interruption point storage section.

The structured document converting method may generate a state transition rule that establishes a condition for identifying an extraction end of difference information, detect the extraction end of the difference information accompanying the state transition according to the state transition rule, and restart the sequential output to the template when the extraction end of the difference information that should be applied to the interruption point of the current output is detected.

The structured document converting method may generate a state transition rule that establishes a condition for identifying an extraction end of difference information based on the maximum appearance number of times of element or the appearance order of element shown as a rule of the document structure of the pre-converted structured document.

A structured document converting program according to an exemplary aspect of the invention is a program causes a computer to execute: conversion rule analyzing processing for generating a state transition rule that establishes analysis information of a sequential analysis result to an input structured document as an event to each state associating with a template of a converted structured document and a document structure of a pre-converted structured document according to a predetermined conversion rule, the state transition rule establishes a state of destination and information that is extracted as predetermined difference information to be applied to the template; state transition processing for transiting a state and extracting difference information 0 or more that should be extracted according to the state transition rule generated by a conversion rule analyzing section when receiving the analysis information showing the sequential analysis result to the pre-converted structured document; and in a course of outputting information formed as a part of the converted structured document to the template by applying the difference information extracted by the state transition processing or difference information accumulated in a predetermined difference information storage section, difference applying processing for applying and outputting the extracted difference information when the difference information is applicable to a template immediately, and if not accumulating the difference information in the difference information storage section and waiting for next difference information extraction.

The structured document converting program may cause the computer to, in the conversion rule analyzing processing, divide the converted structured document every part structure to be grouped as an output unit and generate a template when the output unit forms a group and generate a state transition rule that establishes that when the state transits to a state corresponding to a first element of a part structure to be grouped as an output unit, the template corresponding to the part structure is output, and specify a template to be outputted according to the state transition rule in the state transition processing.

The structured document converting program may cause the computer, in the difference applying processing, to interrupt a sequential output and store an interruption point and information showing difference information that should be applied to the point in a predetermined output interruption point storage section when the information formed as a part of the converted structured document cannot be obtained even if the difference information accumulated in the difference information storage section is applied to the template and when the difference information is extracted, the program may cause the computer to determine whether the difference information can be applied to the template immediately based on an identifier of the extracted difference information and the information showing the difference information stored in the output interruption point storage section.

The structured document converting program may cause the computer to generate a state transition rule that establishes a condition for identifying an extraction end of difference information in the conversion rule analyzing processing, detect the extraction end of the difference information according to the state transition rule in the state transition processing, and restart the sequential output to the template when the extraction end of the difference information that should be applied to the interruption point of the current output is detected in the difference applying processing.

The structured document converting program may cause the computer to generate a state transition rule that establishes a condition for identifying an extraction end of difference information based on the maximum appearance number of times of element or the appearance order of element shown as a rule of the document structure of the pre-converted structured document in the conversion rule analyzing processing.

### EFFECT OF THE INVENTION

The first effect of the present invention is to perform conversion processing not always requiring a memory area enough for storing all output documents or a memory area enough for reading all input documents. The reason is because an operation is configured to use a sequential analysis for an analysis of the input document, and, according to a received analysis result, to output a point that can be output sequentially, and to accumulate only information that cannot be output immediately.

The second effect of the present invention is to perform outputting sequentially by describing, as the conversion method, only information showing a correspondency of individual elements in a conversion rule regardless of an input order even when an element output order of an input document is different from that of an output document. The reason is because whether difference information extracted from the input document should be accumulated is determined by whether the difference information corresponds to a point interrupting the output currently and not by information described in the conversion rule.

The third effect of the present invention is to convert a structured document according to a conversion rule described by the XSLT that is a standard specification. The reason is because only information defined by the XSLT is used, while an output document schema or a specification of buffering method for element is not needed.

### BEST MODE FOR CARRYING OUT THE INVENTION

Exemplary embodiments of the present invention will be described with reference to the drawings.

### A First Exemplary Embodiment

FIG. 1 is a block diagram showing a constitution example of a structured document conversion system 100 according to a first exemplary embodiment of the present invention. The structured document conversion system 100 shown in FIG. 1 comprises a structured document analyzing section 110, a structured document converting device 120 and a structured document sequentially outputting section 130.

The structured document converting device 120 includes a conversion rule analyzing section 121, a state transition rule storage section 122, an output template storage section 123, a state transition section 124, a difference applying section 125, a difference information storage section 126, and a portion-in-output storage section 127.

The structured document conversion system 100 implements a method to implement the sequential output of an output structured document to the sequential analysis of an input structured document as possible. Also, a conversion rule inputted into the structured document conversion system 100 should include a document structure of a structured document to be generated after the conversion (output structured document) and a correspondence of a constituent element included in the document structure and a constituent element included in a document structure of a structured document to be inputted (input structured document). For example, a conversion rule is information showing the document structure of the output structured document, and, may be information described in a description form showing which extracted constituent element in the document structure of the input structured document corresponds to the constituent element of the structured document.

Information stored to each storage section will be described.

The state transition rule storage section 122 accumulates a state transition rule 140 generated by the conversion rule analyzing section 121. The state transition rule 140 is a guide for state transition processing of the state transition section 124, and is information that defines what kind of state transition can be taken or contents of processing about at least information extraction in each state according to the document structure of the input structured document. Note that, when plural templates corresponding to the document structure of the inputted structured document exist, information that defines contents of processing about template output may be included.

FIG. 2 is an illustration showing an example of the state transition corresponding to a hierarchical structure of a certain structured document. The example shown in FIG. 2 is an example of the state transition where processing has to be performed on ‘a/b1/c’ (tag c in tag b1 in tag a) and ‘a/b2/c’ (tag c in tag b2 in tag a) included in the input structured document by the conversion rule. As shown in FIG. 2, in the hierarchical structure (‘a/b1/c’ and ‘/a/b2/c’) of the input structured document shown by the conversion rule, the conversion rule analyzing section 121 defines each state in which each tag (beginning tag of the element) in each hierarchy from a route to a tag to be processed as an event of the state transition. In this example, state 0 is associated with the initial state (before inputting target document), and state 1 is associated with the route in advance. Furthermore, more specifically, state 2 of destination from state 1 based on the start of tag a in the route, state 3 of destination from state 2 based on the start of tag b1 in tag a, state 4 of destination from state 2 based on the start of tag b2 in tag a, state 5 of destination from state 3 based on the start of tag c in tag b1 in tag a, and state 6 of destination from state 4 based on the start of tag c in tag b2 in tag a are defined. That is, each state represents in-processing of each factor in each hierarchy, and when a start of a lower element is accepted during the processing of the element, the state transits to a state where the lower element is set as an event of the state transition (an in-processing state of lower element). By returning to a state where the end of the element is accepted (returning to a state before the state transition), the state comes back to the in-processing state of the upper element that is upper than the element being processed.

By determining the state of such a transition condition, a state identifier can identify which hierarchy of the input structured document a currently analyzed element locates in. This means that even if an element having the same name (e.g., element c) appears in the input structured document, it can be determined whether the element is an element to be processed without confirming what kind of element appeared before (i.e., only with information of the existing element outputted sequentially).

A state transition rule not depending to the document structure of the input structured document such as returning performed by the end of the element may be out of the subject of the state transition rule 140 accumulated in the state transition rule storage section 122

FIG. 3 is an illustration showing an example of the state transition rule 140. As shown in FIG. 3, the state transition rule 140 may be information in which a state number, input information, destination information, output template information and extraction information are associated with each other. An example of the state transition rule 140 for the state transition performed by the start of the element is shown in FIG. 3. Here, the state number is information to identify a state. The input information is an event to be a condition for the state transition and is equivalent to analysis information in the exemplary embodiment. The destination information is information showing a state of the destination when the input information is received. The output template information is information showing a template to be outputted when the state transits to a state shown in the destination information. The extraction information is information showing information to be extracted when the state transits to a state shown in the destination information by associating with difference information. If it is needed to extract selected elements such as value-of or copy-of in the XSLT, information for applying to a template should be shown.

Here, the difference information is information shown by a partial structure extracted from the input structured document, and is applied to the output structured document, and it is information to be difference between the output structured document and the template. The preferred example is a consecutive sequential analysis result string (information showing the partial document extracted from the input structured document). For example, it may be a single element name, an attribute name, an element value, or an attribute value, and it may be information having a structure including a plurality of element names, attribute names, element values, or attribute values as constituent elements like the upper element in the hierarchical structure. Also, another preferred example is information forming a partial structure of the output structured document constructed from the sequential analysis result string. For example, it may be information of a result of a predetermined calculation performed on a certain element of the input structured document. The difference information may be a part of the structured document that reduces a utilizing memory area by a compression technique as shown in, for example, Japanese Patent Laid-Open No. 2004-302799.

In the exemplary embodiment, by giving an identifier for identifying the difference information (difference information ID) to the difference information, an application point in the output template 150 is associated with the difference information shown by the extracted information of the state transition rule 140. When the same difference information is applied to plural points, the number of applying times may be given to one difference information ID, thereby it may be managed whether the difference information should be maintained even after applying.

For example, state number=1, input information=“a”, and destination information=2 are registered in associating with each other; and output template information=“template-2” and extraction information=“@ at→ID: 2” are also associated with each other in FIG. 3. This means that state 1 transits to state 2 when a start of element a is accepted, and that a value of attribute “at” of the existing element a is extracted as a difference information ID=1 in changing to state 2. Note that, “→,” in the extraction information is used as a sign showing the correspondency with the difference information. Further, “A B” shows that information A in the input structured document is extracted as the difference information identified by the difference information ID=B. Furthermore, “→” is used as a sign showing an existing element (i.e., an element associated with a state of the transition), “@ xx” is a sign showing an attribute xx belonging to the existing element, and “node ( )” is a sign showing all attributes, element, and character strings belonging to the existing element. Note that, an example showing extracting all information extracted in the state in an additional form to the difference information ID=B may be shown using “→B+”.

The output template storage section 123 accumulates the output template 150 made by the conversion rule analyzing section 121. The Output template 150 is a template (document information) to make the output structured document corresponding to the input structured document, and where a frame of the output structured document is described according to the document structure of the output structured document; and the output template 150 is also a template which indicates, about a point requiring difference information such as a point where the structural element extracted from the input structured document is reflected, information for applying the difference information. The preferred example for accumulating the output template is maintaining it in the form of the sequential analysis result string showing the output structured document, and assigning a special para-analysis result string associated with an identifier for identifying the difference information to the point requiring the difference information. Whereas the special para-analysis result string is not defined in the standard specification of the sequential analysis result string corresponding to the structured document, but it refers to an analysis result string imitating the standard specifications. An example in the XML is an analysis result string imitating an SAX (The Simple API for XML). Note that, the description about the point requiring the difference information should be the form enough for showing that the point is necessary for the difference information and what kind of difference information is required when the difference applying section 125 reads the generated template sequentially.

In the presence of the description that an output unit is processed as a group, for example, when a unit repetitively outputted in the document structure of the output structured document (template, for-each, copy-of, or the like in the XSLT) is shown, the conversion rule analyzing section 121 generates a template divided for the group of the output unit (for every partial structure to be grouped as an output unit) to enable sequential output of the output structured document. In such a case, a larger template including the above templates is also generated. In the larger template, a divided template to be included is recognized as one piece of the difference information.

The difference information storage section 126 accumulates difference information extracted by extraction information of the state transition rule 140 in sequential analyzing processing of an input structured document, and not corresponding to an output point in the sequential output processing of the template. Specifically, the difference information storage section 126 accumulates difference information where a point that should apply the difference information appears later than a point interrupting the output in a template outputted sequentially. As for the difference information accumulated to the difference information storage section 126 once, the accumulation is canceled by coping with the output point in the sequential output processing of a template restarted by the extraction end of the difference information corresponding to the output interruption point.

The portion-in-output storage section 127 stores an output interruption point of template becoming an applying waiting point of the difference information in the sequential reading processing of the template. The portion-in-output storage section 127 may include not only information that the point of the template is specified but also information about the difference information that should be applied to the point.

Then, an outline of processing of every processing section is described. The structured document analyzing section 110 performs a sequential analysis to the input structured document, and sequentially outputs information about an element or contents appearing in the detected input structured document, as analysis information. For example, the structured document analyzing section 110 may be an XML parser corresponding to the SAX. Specifically, the structured document analyzing section 110 reads the input structured document sequentially, and when a predetermined description concerning the document structure of the input structured document is detected, the structured document analyzing section 110 should output information concerning the document structure shown by the description or information about the element or contents as an event each time. In this exemplary embodiment, at least, the start of element (including which factor is started), the end of the element (including which factor is started), and the end of the document are output as analysis information sequentially. In a case that want to be converted into a document structure that uses the element of a character string value or the input structured document as it is, it allows it to output as analysis information about the other information that can be acquired from the input structured document such as a character string of the element content or attribute contents belonging to the element as well as the above. Note that, it needs not to be necessarily output as an event, and, for example, for analysis information to be provided from a certain part structure, reference information to refer to the analysis information concerning the part structure when information about the part structure is output as an event is added, thereby it may allow it to acquire separately before the analysis of the part structure completes.

When a conversion rule to convert the input structured document into a structured document having a desired document structure is input, the conversion rule analyzing section 121 makes the state transition rule 140 and the output template 150 based on the conversion rule. Also, the generated state transition rule 140 and the output template 150 are accumulated to the state transition rule storage section 122 and the output template storage section 123, respectively.

The state transition section 124 receives the analysis information outputted sequentially, and performs state transition processing to the information shown by the analysis information according to the state transition rule established to the input information. In the state transition processing, a state transits when the destination is established; a template is outputted when the template to be outputted is determined; information is extracted as the difference information when the information to be extracted is determined and is applied to the template when the template is capable of applying. The generated state transition rule 140 coping with the document structure of the input structured document accumulated to the state transition rule storage section 122 is used as the state transition rule. About the state transition processing not depending on the document structure of the input structured document, the processing can be performed according to a predetermined state transition rule. When input information showing the element end is accepted, the state transition section 124 terminates an application of the difference information when the element is an element that the difference information is extracted from. Also, as for the outputting processing of the template and the applying processing of the difference information to the template, the state transition section 124 instructs instructions (a template output instruction, a difference application instruction) to the difference applying section 125 to perform the actual processing.

The difference applying section 125 performs the template output processing and the application processing of the difference information to the template (difference information application processing) according to instructions from the state transition section 124. In the template output processing, the template to be outputted is read from the output template storage section 123 sequentially, and information formed as a part of the output structured document is outputted sequentially until the information is not provided. As a result of the sequential analysis performed on the template, if it is a point not requiring the difference information, the difference applying section 125 should output the information of the read template as it is as information formed as a part of the output structured document. Also, even if it is a point requiring the difference information, when the difference information to be applied to the point is accumulated to the difference information storage section 126, the difference applying section 125 should apply the difference information to the point and output it as information formed as a part of the output structured document. When information formed as a part of the output structured documents is not provided, i.e., when the difference information corresponding to the point requiring the difference information is not accumulated to the difference information storage section 126, the difference applying section 125 interrupts the sequential outputting and stores the point to the portion-in-output storage section 127 as a point in outputting currently.

Also, in the difference information application processing, it is judged whether the extracted difference information is difference information corresponding to the point in outputting stored in the portion-in-output storage section 127, and, if it is the corresponding difference information, the difference information is applied to the point. A restart timing of the template output processing is when a notification of completion of corresponding difference information extraction is accepted. Here, in a case that a template outputted repeatedly is recognized as one difference information, the completion of the difference information extraction should be notified when the end of the upper element in the part structure coping with the template is detected. On the other hand, when it is not the corresponding difference information, it is accumulated to the difference information storage section 126. Note that, even when the difference information is applied to the point in outputting, if the number of application times is given to the difference information ID, the difference information is accumulated to the difference information storage section 126 until the number of application times is reached.

The structured document sequentially outputting section 130 documents information outputted from the difference applying section 125 sequentially, and outputs it sequentially. The information outputted from the difference applying section 125 sequentially is information which the difference information extracted from the input document structure is applied to and is forming a part of the output structured document. Therefore, documenting and outputting the information sequentially equals to outputting a part document of the output document structure sequentially. Note that, the difference applying section 125 can output information formed as a part of the output structured document in a documented state. In such a case, the structured document sequentially outputting section 130 is omitted.

Then, an operation of the present exemplary embodiment is described with reference to flow charts of FIG. 4 to FIG. 8. FIG. 4 is a flow chart showing an outline operation of the structured document conversion system 100. At first, when a conversion rule is input into the structured document conversion system 100, the conversion rule analyzing section 121 analyzes the conversion rule (step A1). Based on the received conversion rule, the conversion rule analyzing section 121 generates the state transition rule 140 showing a state transition condition or an extracting method of elements and the output template 150 becoming a template of the output structured document (step A2), and then accumulates (store) them to the state transition rule storage section 122 and the output template storage section 123, respectively.

For example, the conversion rule analyzing section 121 separates information forming document structure of the output structured document shown in the conversion rule every output unit and makes them as a model of the template. For the point requiring the difference information, the output template 150 should be generated by assigning an identifier for identifying the difference information and describing the point in a special para-analysis result sequence associated with the identifier.

Also, for example, the conversion rule analyzing section 121 should assign a state number to each element in each hierarchy of the hierarchical structure of the input structured document shown in the conversion rule to determine a state; and when there is an element (a lower element) locating in lower than an element corresponding to the state, the conversion rule analyzing section 121 should register the state number corresponding to the lower element to the state transition rule 140 as transition information by associating it with the input information showing the start of the lower element. Furthermore, for the difference information shown by the identifier assigned when the output template 150 is made, the conversion rule analyzing section 121 should identify a position (an element) in the document structure of the input structured document from which the difference information can be extract, and register the information for extracting the difference information to the state transition rule 140 as extraction information in the state corresponding to the element.

Then, the structured document conversion system shifts to an input structured document waiting state (step A3), and when an input structured document is input, the structured document conversion processing is started (step A4).

FIG. 5 is a flow chart showing an example of the structured document conversion processing (step A4 of FIG. 3). In the structured document conversion processing, at first, the structured document analyzing section 110 performs a sequential analysis to the input structured document (step B1), and outputs sequentially the analysis result to the output template storage section 123 as analysis information. The state transition section 124 performs the state transition processing corresponding to the current state according to the analysis information outputted sequentially. At first, the state transition section 124 branches processing according to a kind of the analysis information (step B2).

When the analysis information shows the start of the element, it is judged whether an element started newly is an element requiring state transition (step B3). When it is not an element requiring state transition (No of step B8), the processing shifts to step B8, when it is an element requiring state transition (Yes of step B8), the element transits to the next state according to the state transition rule 140. Note that, whether it is an element requiring state transition and the state of the destination should be confirmed by the contents of the destination information in the state transition rule 140 corresponding to the current state.

Then, it is confirmed whether there is a template which should be output (step B5), and when there is a template which should be output (Yes of step B5), a new template is set as an output object according to the state transition rule 140 (step B6), and a new template output instruction is notified to the difference application region 125. The difference applying section 125 performs the template output processing to the new template to be outputted according to the instruction from the state transition section 124 (step B7). Note that, whether there is a template that should be output and which template is set as an output object should be confirmed by the contents of the output template information in the state transition rule 140 corresponding to the current state. Also, the detailed flow of the template output processing will be described below.

Next, it is confirmed whether there is information that should be extracted (step B8), and when there is information that should be extracted (Yes of step B8), the information is extracted as difference information together with its identifier by associating with each other (step B9), and a difference application instruction for the extracted difference information is notified to the difference application region 125. The difference applying section 125 performs the difference information application processing to the outputting template for the extracted difference information according to the instruction from the state transition section 124 (step B10). Note that, whether there is information that should be extracted and what kind of information is extracted as which difference information should be confirmed by the contents of the extraction information in the state transition rule 140 corresponding to the current state. Also, the detailed flow of the difference information application processing will be described below.

If the analysis information shows the end of the element in step B2, when the element is an element that transits a state in step B4 (Yes of step B11), the state transition section 124 returns to the state before the transition (step B12); and when the state corresponding to the element is in a state that the difference information should be extracted, the state transition section 124 notifies the difference application region 125 of the completion of the difference information extraction (step B13). When the difference information corresponds to a point in processing, the difference applying section 125 receives the completion of extraction and restarts the template output processing (step B14).

Also, when the analysis information shows the end of the document in step B2, the structured document conversion processing is finished.

Then, a detailed flow of each processing is described. FIG. 6 is a flow chart showing an example of the operating flow of the template output processing. When receiving an output instruction of the template from the state transition section 124, the difference applying section 125 reads a template to be outputted from the output template storage section 123 sequentially as shown in FIG. 6, and outputs a part not requiring the difference information sequentially (step D1). Thus, a template is output sequentially until the point where the difference information is required appears. Here, when the difference information required in the appeared point is accumulated to the difference information storage section 126 (step D2), the difference information is applied to the template, and it is outputted (step D3), and the processing is repeated until a next point requiring the difference information. When a point where necessary difference information is not accumulated appears, the point is stored in the portion-in-output storage section 127 as a point in outputting (step D4), and the processing is finished. For example, an identifier of the difference information that should be applied to the point should be stored together in the portion-in-output storage section 127.

FIG. 7 is a flow chart showing an example of the operating flow of the difference information application processing. When receiving an application instruction of the difference information to the template from the state transition section 124, as shown in FIG. 7, the difference applying section 125 determines whether the difference information is difference information corresponding to the point stored in the portion-in-output storage section 127 and thereby determines whether it can be output immediately (step C1); and when it is determined it can be applied immediately, the difference applying section 125 applies it to the template and outputs sequentially (step C2). Whether it can be applied immediately should be determined by comparing the identifier of the extracted difference information with the identifier of the difference information stored in the portion-in-output storage section 127. On the other hand, when it is determined that it cannot be output immediately, the difference information is accumulated to the difference information storage section 126 (step C4), and the processing is finished.

Next, an effect of the exemplary embodiment will be described. In this exemplary embodiment, the difference applying section 125 is configured to output a part that can be output sequentially; store the part when it is not possible for the sequential output; and when the next difference information arrives, determine whether it corresponds to the point in processing to output it sequentially if it is yes. Therefore, an amount of the difference information to be accumulated to the difference information storage section 126 can be kept small, and the conversion processing can be performed using the memory area which is smaller than that requiring for maintaining the whole input document or the whole output document.

Also, in the exemplary embodiment, the state transition section 124 is configured to extract the difference information showing the application point to a template by a sequential analysis result according to the state transition rule generated based on the conversion rule shown by the correspondence between the document structure of the output structured document and the element. Accordingly, the difference application region 125 can determine whether the differential information corresponds to the point in processing without requiring information about the order in the input document and the order to output to the output document. Therefore, the conversion processing can be performed using a small memory area by describing only the correspondency of individual elements as the conversion method in the conversion rule, even when the order in the input document and the order to output to the output document are different.

Furthermore, the exemplary embodiment is configured to receive a conversion rule beforehand, receive an input structured document next, and output a conversion result as an output structured document. Therefore, it can be replaced with a standard structured document converting device.

### A Second Exemplary Embodiment

Then, a second exemplary embodiment of the present invention is described. FIG. 8 is a block diagram showing a constitution example of a structured document conversion system 200 of the second exemplary embodiment. In FIG. 8, the components making the same part of the structured document conversion system 100 of the first exemplary embodiment are described with the same numerals shown in FIG. 1, and the detailed description is omitted.

As shown in FIG. 8, a structured document conversion system 200 comprises a structured document analyzing section 110, a structured document converting device 220, and the structured document sequentially outputting section 130. Also, the structured document converting device 220 includes a conversion rule analyzing section 221, a state transition rule storage section 222, the output template storage section 123, a state transition section 224, a difference applying section 225, the difference information storage section 126, and the portion-in-output storage section 127.

This exemplary embodiment is an example, which further inputs information about the document structure of the input structured document (input structured document structure information).

The conversion rule analyzing section 221 has a function similar to the conversion rule analyzing section 121, and when input structured document structure information is received, it has a function to make a state transition rule 240 that is the state transition rule 140 additionally having a difference information end notice rule according to the document structure of the input structured document shown by the input structured document structure information. The difference information end notice rule is a condition to identify that certain difference information has been finished extracting. When the maximum appearance number of times of the element is shown by the input structured document structure information, the conversion rule analyzing section 221 should add the difference information end notice rule of that the extraction completion of the difference information concerning the element can be detected when the element appeared for the maximum appearance number of times. The maximum appearance number of times of the element is shown as maxOccurs attribute in the XMLSchema. Also, when the appearance order of elements is described by the input structured document structure information, the difference information end notice rule of that the extraction end of the difference information concerning the previous element can be detected when the next element of the element appears should be added. The appearance order of elements is shown as sequence element in the XMLSchema.

FIG. 9 is an illustration showing an example of the state transition rule 240 additionally having the difference information end notice rule. The difference information end notice rule is registered as end notice information in the state transition rule 140 shown in FIG. 9. For example, in FIG. 9, “→@ at” is shown in the end notice information in destination state 2, and this means that the extraction end of the difference information (difference information concerning attribute “at”) shown by the end notice information can be detected if the state transits to state 2 at least once. The end notice information “# 10→c” in destination state 5 means that the extraction end of the difference information (difference information concerning element c) shown by the end notice information can be detected when the state transits to state 5 for 10 times. Also, for example, in FIG. 9, “→b1” is shown in the end notice information in destination state 4, and this means that the extraction end of the difference information (difference information concerning element b1) shown by the end notice information can be detected if the state transits to state 4 at least once. In FIG. 9, the sign of the element becoming the difference information is shown, but the difference information ID may be registered by associating with it.

The state transition section 224 has a function similar to the state transition section 124, and further has a function to inform the difference applying section 225 of an end notice showing the extraction end of the difference information according to the difference information end notice rule added to the state transition rule 240 in each state transition processing.

The difference applying section 225 has a function similar to the difference applying section 125, and when the difference information end notice is received, the difference applying section 225 further has a function to detect that the extraction of the difference information shown by the end notice is finished, and to restart the template output processing if necessary.

Then, an operation of the exemplary embodiment is described with reference to the flow charts of FIGS. 10 and 11. FIG. 10 is a flow chart showing an example of the structured document conversion processing of the exemplary embodiment. In FIG. 10, the same numerals are given to the operation similar to the processing flow of the structured document conversion processing shown in FIG. 5, therefore the detailed description is omitted.

In step E1 of FIG. 10, when the extraction end of the difference information is detected based on the difference information end notice rule corresponding to the current state (step E1), the state transition section 224 notifies the difference applying section 225 of end information showing the end of the difference information. When receiving the end information, the difference applying section 225 performs the difference information end processing (step E2).

FIG. 11 is a flow chart showing an example of the difference information end processing. When receiving the end information from the state transition section 224, if the received end information is concerning the difference information corresponding to the point in outputting described in the portion-in-output storage section 127 (step F1), the difference applying section 225 judges that the all output of the difference information has completed and restarts the template output processing for the following templates (step F2). The template output processing is similar to the template output processing shown in FIG. 6. On the other hand, if the end information is concerning the difference information not corresponding to the point in outputting, the end information is stored as the difference information showing the end in the difference information storage section (step F3), and the processing is finished.

According to the exemplary embodiment, the end information can be received without waiting for an analysis result of the end of the element, and even if the conversion processing must be performed to an unexpected element, the end information can be received without waiting for an analysis result of the end of the upper element, thus, the template output processing can be restarted immediately. Thus, an accumulation amount of the difference information within that period can be reduced.

### A Third Exemplary Embodiment

Next, a third exemplary embodiment of the present invention is described. FIG. 12 is a block diagram showing a constitution example of a structured document conversion system 300 of the third exemplary embodiment. In FIG. 12, the components making the same part of the structured document conversion system 100 of the first exemplary embodiment are described with the same numerals shown in FIG. 1, and the detailed description is omitted.

This exemplary embodiment is a constitution example in a case when the operations of each means of the structured document converting device 120 in the first exemplary embodiment are implemented by a program, the structured document converting device 120 is a computer that reads the program and works.

A structured document converting device 320 comprises a control section 328 and a storage section 329.

The storage section 329 stores a program for causing the control section 328 to build each storage section included in the structure document converting device 120 in the first exemplary embodiment (the state transition rule storage section 122, the output template storage section 123, the difference information storage section 126, and the portion-in-output storage section 127) in the storage section 329, and to execute the processing of each processing section included in the structure document converting device 120 (the conversion rule analyzing section 121 and the state transition section 124).

The control section 328 reads the program from the storage section 329, and works according to the program. Specifically, the control section 328 builds the transition rule storage section 122, the output template storage section 123, the difference information storage section 126, and the portion-in-output storage section 127 in the storage section 329 according to the program. Also, while reading or writing data from/to the storage section 329, the control section 328 performs processing similar to the processing of the conversion rule analyzing section 121 and the state transition section 124 in the first exemplary embodiment.

The structured document converting device 220 in the second exemplary embodiment shown in FIG. 8 can be also implemented by the control section 328 and the storage section 329 like the present exemplary embodiment.

Next, an operation of the exemplary embodiment will be described using an example (a first example). In this example, an example to convert an XML document according to a conversion rule described in the XSLT using the structured document conversion system 200 shown in the second exemplary embodiment.

FIG. 13 is an XSLT document showing the conversion rule in this example. Also, FIG. 14 is an XMLSchema document showing the input structured document structure information in this example.

The conversion rule analyzing section 221 that receives the input makes the state transition rule 240 and the output template 250. FIG. 15 is an example of the state transition rule 240 generated in this example. Also, FIG. 16 is an example of the output template 250 made in this example.

In the XSLT document shown in FIG. 13, “template”, “for-each”, and “copy-of”, which an output unit is processed as a group, are shown. Therefore, three divided output templates 250 as shown in FIG. 16 are generated. That is, three templates of “RootTemplate”, “Template-1” and “Template-2” are generated as the output template 250. And, a point where the difference information should be applied in each template is described in a special para-analysis string imitating the SAX in association with a difference information ID shown by PATCH:XX.

Also, it can be understood that “/”, “/a/b1/c@name”, “/a/b1/c/d2”, “/a/b1/c/d1”, “/a/b2/c below” are necessary for the conversion processing in the output structured document by the XSLT document shown in FIG. 13. Therefore, a state that makes possible of identifying these elements are defined. In this example, as shown in FIG. 15, initial state 0, state 1 corresponding to the route (“/”), state 2 of destination from state 1 based on the start of tag a in the route, state 3 of destination from state 2 based on the start of tag b1 in tag a, state 4 of destination from state 2 based on the start of tag b2 in tag a, state 5 of destination from state 3 based on the start of tag c in tag b1 in tag a, and state 6 of destination from state 4 based on the start of tag c in tag b2 in tag a are defined. A state number, input information and destination information should be registered according to each hierarchy relations if a state is defined. In this example, a definition of the state of destination from state 5 based on tags d1 and d2 is omitted. The reason is because the necessary processing for tags d1 and d2 only extracts the content, and does not require the processing for the lower elements.

And, information that should be extracted in each state is registered to the extract information in association with an application point of the template. Herein, it is registered in association with a difference information ID shown by PATCH:XX.

Also, because maxOccurs=10 is defined as an attribute of element c in element b2 in the XMLSchema document shown in FIG. 14, information showing that element c no longer appears when element c appears equal to or more than 10 times is registered in the end notice information of the state transition rule 240.

Further, as shown in FIG. 11, because it is described that element b1 and element b2 appear in element a only in the described order by sequence element, information showing that element b1 no longer appears when element b2 appears is registered in the end notice information of the state transition rule 440. It is similar to the order of element d2 and element d1. Furthermore, because the attribute appears to the element only once, information about @ name is also registered in the end notice information.

Next, a flow of the structured document conversion processing is described with a case that an input XML shown in FIG. 17 is inputted as an input structured document. When a sequential analysis to the input XML starts (step B1), the state transition section 224 shifts to step B3 because the analysis information of the document element start (here it means a start of route element ‘/’) is provided. Since the state transition rule 240 prescribes that state 0 transits to state 1 when the input information showing the start of route element ‘/’ is obtained, it is determined that the state should be transited and the state transits to state 1 (steps B3 and B4). Then, since “RootTemplate” is registered as a template which should be output when the state transits to state 1, a template to be outputted is set to RootTemplate, and the difference applying section 225 performs the template output processing to the RootTemplate (steps B6 and B7).

The difference applying section 225 reads RootTemplate accumulated to the output template storage section 123 sequentially, and outputs a point not requiring the difference information sequentially (step D1). Here, because a point requiring the difference information appears when the second “{Template-1}” is read, the first element “<root>” which has been already read is outputted. Because the difference information corresponding to the second point (all difference information applied to Template-1) is not accumulated to the difference information storage section 126 (No of step D2), information showing that the second element of RootTemplate is outputting (e.g., “2, Template-1” as an output point on RootTemplate) is stored in the portion-in-output storage section 127 as a point in outputting (step D4). Thus, the state transition processing for the analysis information of the document element start is finished, and the processing returns to step B2.

Then, the analysis information of the start of element a is obtained. The state transition section 224 goes to step B3 according to a type of the information. Then according to the state transition rule 240, state 1 transits to state 2. Because neither the output template information nor the extraction information nor the end notice information is registered in state 2, the state transition processing for the analysis information of the start of element a is finished as it is. Further, when the analysis information of the start of element b1 is obtained, state 2 transits to state 3 similarly.

Then when the analysis information of the start of element c is obtained, the state transition section 224 shifts the state to state 5 according to the state transition rule 240. And, a template to be outputted is set to Template-1, and the difference applying section 225 performs the template output processing to Template-1 (steps B6 and B7).

The difference applying section 225 reads Template-1 accumulated to the output template storage section 123 sequentially, and outputs a point not requiring the difference information sequentially (step D1). Here, when the third “{value-of (Patch: 1-1)}” is read, a point requiring the difference information appears. Therefore, when the first element “<x1>” to the second element “<y1>” that have been already read are outputted. Because the difference information Patch: 1-1 corresponding to the third point is not accumulated to the difference information storage section 126 (Nₒ of step D2), information showing that the third element of Template 1 is outputting (e.g., “3, Patch 1-1” as an output point on Template-1) is stored in the portion-in-output storage section 127 as a point in outputting (step D4).

Subsequently, because the information to be extracted is described in the state transition rule 240 (step B8), a value of attribute name (“name-1”) is extracted as the difference information Patch: 1-1 (step B9), and the difference applying section 225 perform the difference application processing to apply the difference information Patch: 1-1 to the template (step B10).

Because the notified difference information Patch: 1-1 is difference information corresponding to the point in outputting described in the portion-in-output storage section 127 (Yes of step C1), the difference applying section 225 applies the content of the difference information (a value of attribute name “name-1”) to the point, and outputs it (step C2). Here, by substituting the content of the difference information for “Patch of 1-1” of the para-analysis result string “{value-of (Patch: 1-1)}” read at the point in outputting, it can be outputted as information (“name-1”) forming a part of the output structured document.

Subsequently, because the end information is described in the state transition rule 240 (step E1), the difference applying section 225 performs the difference end processing to the difference information concerning the attribute name (i.e., the difference information Patch: 1-1) (step E2). Since the difference information Patch: 1-1 relates to the difference information corresponding to the point in outputting (step F1), the difference applying section 225 judges that all output of the difference information has been completed and restarts the template output processing for the following template (step F2). By restarting the template output processing, the fourth element “</y1>” to the fifth element “<y2>” of Template-1 are outputted, the sixth element “{value-of (Patch: 1-2)}” is read, and the sequential output is interrupted. Here, “6, Patch1-2” is stored to the portion-in-output storage section 127 as an output point on Template-1.

Then, when the analysis information of the start of element d1 is obtained, a value of element d1 (“text-1”) is extracted as the difference information Patch: 1-3 according to the extract information without transiting the state (step B9), and the difference applying section 225 perform the difference application processing to apply the difference information Patch: 1-3 to the template (step B10). Because the difference information Patch: 1-3 is not the difference information Patch: 1-2 corresponding to the point in outputting described in the portion-in-output storage section 127 (No of step C1), the difference applying section 225 stores the difference information in the difference information storage section 126 (step F3). In this example, the difference information is accumulated to the difference information storage section 126 for the first time here. For example, the difference information storage section 126 may accumulate information such as Patch: 1-3=“text-1”.

Then, when the analysis information of element d2 is obtained, a value of element d2 (“text-2”) is extracted as the difference information Patch: 1-2 according to the extract information without transiting the state (step B9). Because the difference information Patch: 1-2 is the difference information corresponding to the point in outputting (Yes of step C1), the difference applying section 225 applies the content of the difference information (“text-2” which is a value of element d2) to the point, and outputs it (step C2). Here, “text-2” is outputted.

Also, according to the end notice information, it is detected that an appearance of the difference information concerning element d1 is finished, and end information showing the end of the difference information concerning element d1 (the difference information Patch: 1-3) is notified, thereby the difference applying section 225 performs the difference information end processing (steps E1 and E2). Because the difference information Patch: 1-3 is the difference information not corresponding to the point in outputting, the difference applying section 225 accumulates the end information to the difference information storage section 126 as a kind of the difference information (No of step F1, and F3).

When the analysis information of the end of element c is obtained (step B10), since the element has been performed the state transition (step B11), the state is returned to state 3 that is a state before the state transition (step B12) and it is notified that the extraction of the difference information that should be extracted in a state corresponding to element c (the difference information Patch: 1-2, Patch: 1-3) is finished to the difference applying section 225 (step B13). Because the difference information Patch: 1-2 is the difference information corresponding to the point in outputting (Yes of step F1), the difference applying section 225 judges that all output of the corresponding difference information has been completed and restarts the template output processing for the following template (step F2). Here, the seventh and eighth elements of Template-1 are outputted. Then, the ninth element is outputted using the difference information Patch: 1-3 accumulated to the difference information storage section 126. Then, the tenth and 11th elements are outputted. Finally, all output as the difference information Template-1 is completed. Accordingly, it is judged that all output of the difference information Template-1 that is the third element of RootTemplate has been completed, and finally, at a point of time when the third element of RootTemplate is read, “3, Template-2” is stored in the portion-in-output storage section 127 as a point in outputting of RootTemplate (step D4).

Element ‘a/b2/c’ is outputted by performing the state transition processing similarly, and the output document structure shown in FIG. 16 is finally outputted. And when the analysis information of the document end is obtained (step B14), the converting processing is finished (step B15).

### INDUSTRIAL APPLICABILITY

The present invention is applicable to an application such as an Enterprise service bus that converts a structure of an input structured document and serves it for connecting a plurality of service. The present invention is also applicable to an application such as an XIVIL database that arranges a search result and returns it to a client. For example, the present invention can be applied as the XML database that converts an input structured document matching with a given query to an output structured document that can be recognized by a client and returns it, or the XML database that an XSLT is designated as a query and an XML document in the database at that time is converted using the designated XSLT and the converted result is returned as a search result.

This application is based upon and claims the benefit of priority from Japanese patent application No. 2007-139934, filed on May 28, 2007, the disclosure of which is incorporated herein in its entirety by reference.

### BRIEF DESCRIPTION OF DRAWINGS

FIG. 1 is a block diagram showing a constitution example of a structured document conversion system 100 according to a first exemplary embodiment;

FIG. 2 is an illustration showing an example of a state transition corresponding to a hierarchical structure of a certain structured document;

FIG. 3 is an illustration showing an example of a state transition rule 140;

FIG. 4 is a flow chart showing an operation of the structured document conversion system 100;

FIG. 5 is a flow chart showing an example of the flow of structured document conversion processing;

FIG. 6 is a flow chart showing an example of the flow of template output processing;

FIG. 7 is a flow chart showing an example of the flow of difference information application processing;

FIG. 8 is a block diagram showing a constitution example of a structured document conversion system 200 according to a second exemplary embodiment;

FIG. 9 is an illustration showing an example of a state transition rule 240 that is added a difference information end notice rule;

FIG. 10 is a flow chart showing an example of the flow of structured document conversion processing according to the second exemplary embodiment;

FIG. 11 is a flow chart showing an example of the flow of difference information end processing according to the second exemplary embodiment;

FIG. 12 is a block diagram showing a constitution example of a structured document conversion system 300 according to a third exemplary embodiment;

FIG. 13 is an XSLT document showing a conversion rule in a first example;

FIG. 14 is an XMLSchema document showing input structured document structure information in the first example;

FIG. 15 is an example of the state transition rule 240 made in the first example;

FIG. 16 is an example of the output template 250 made in the first example;

FIG. 17 is an XML document showing an example of the input structured document in the first example; and

FIG. 18 is an XML document showing an example of the output structured document made in the first example.

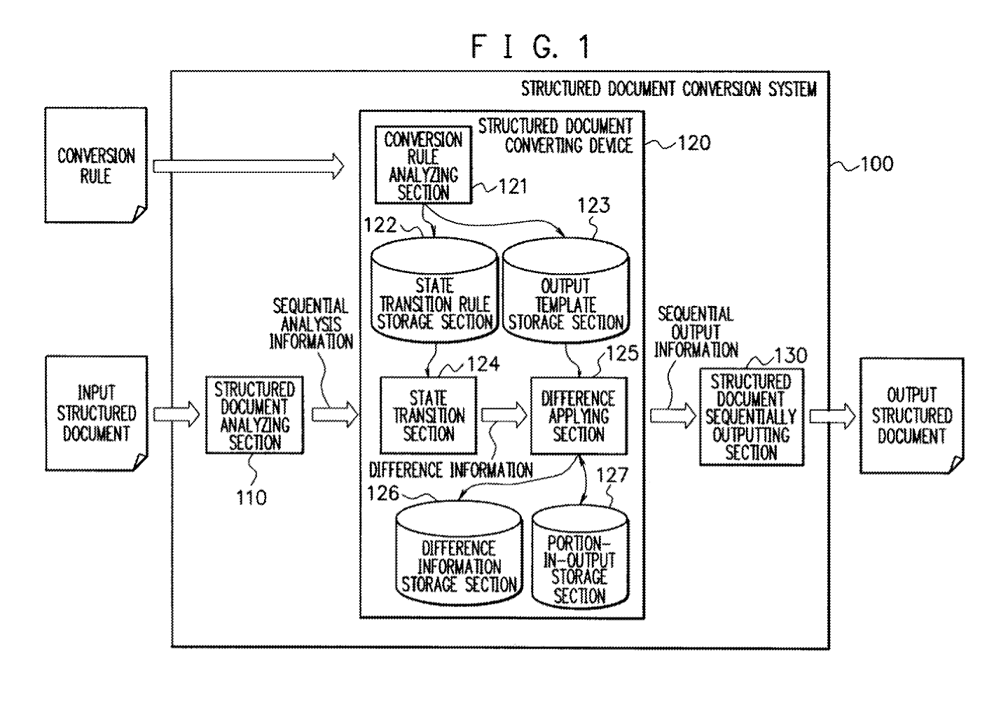

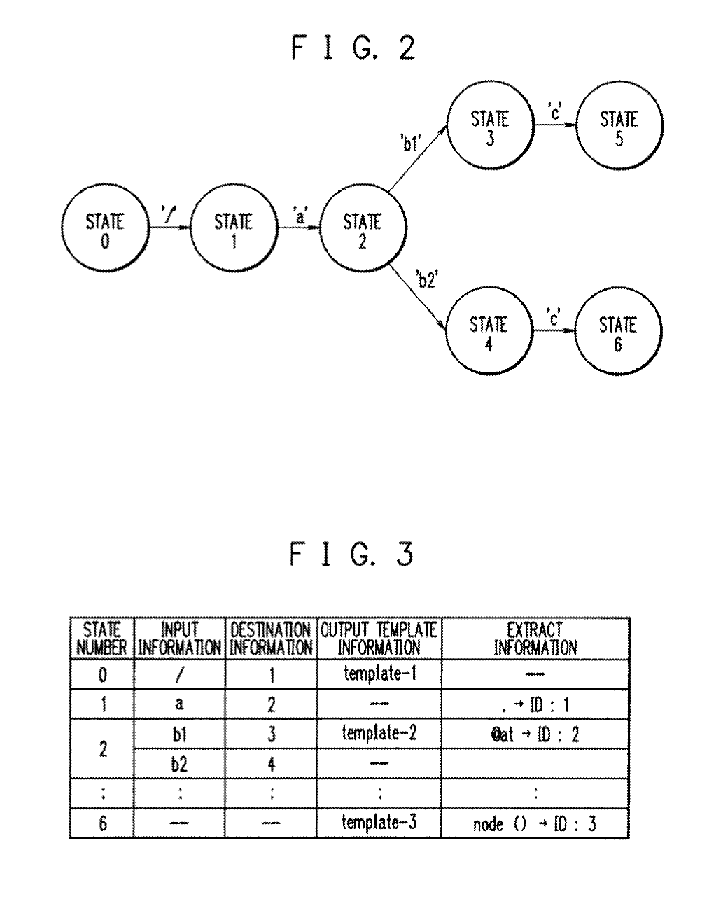

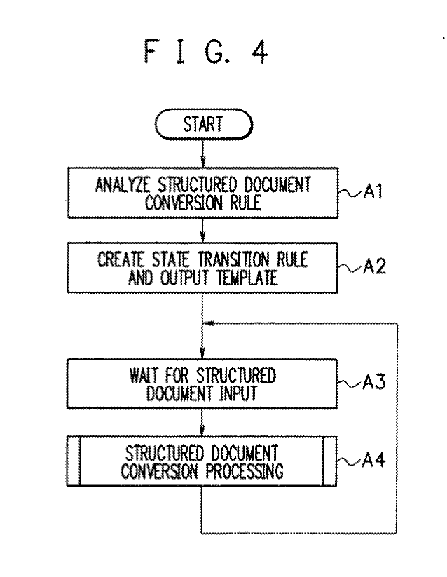

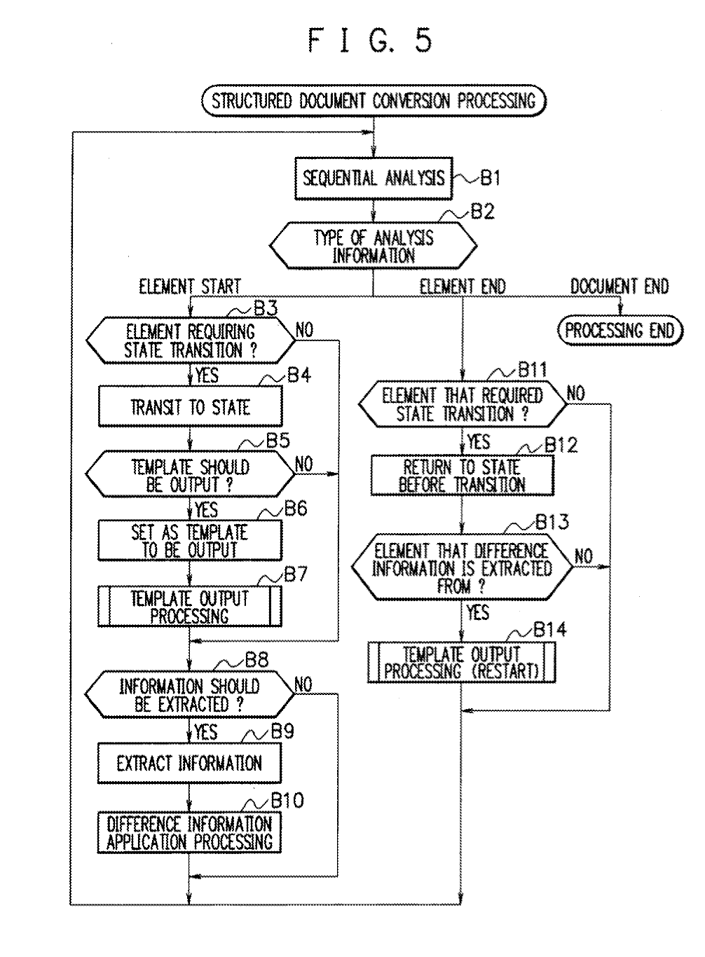

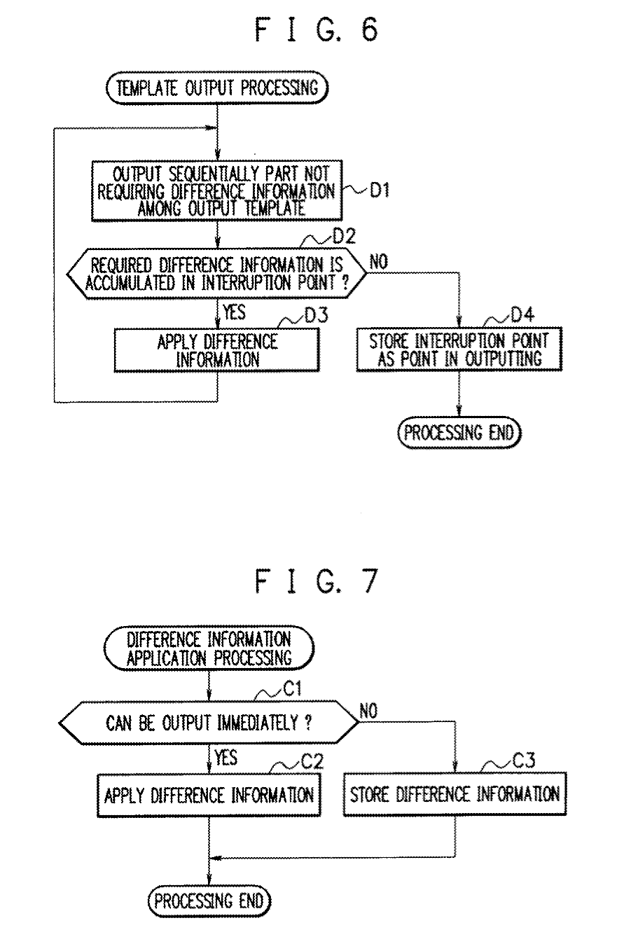

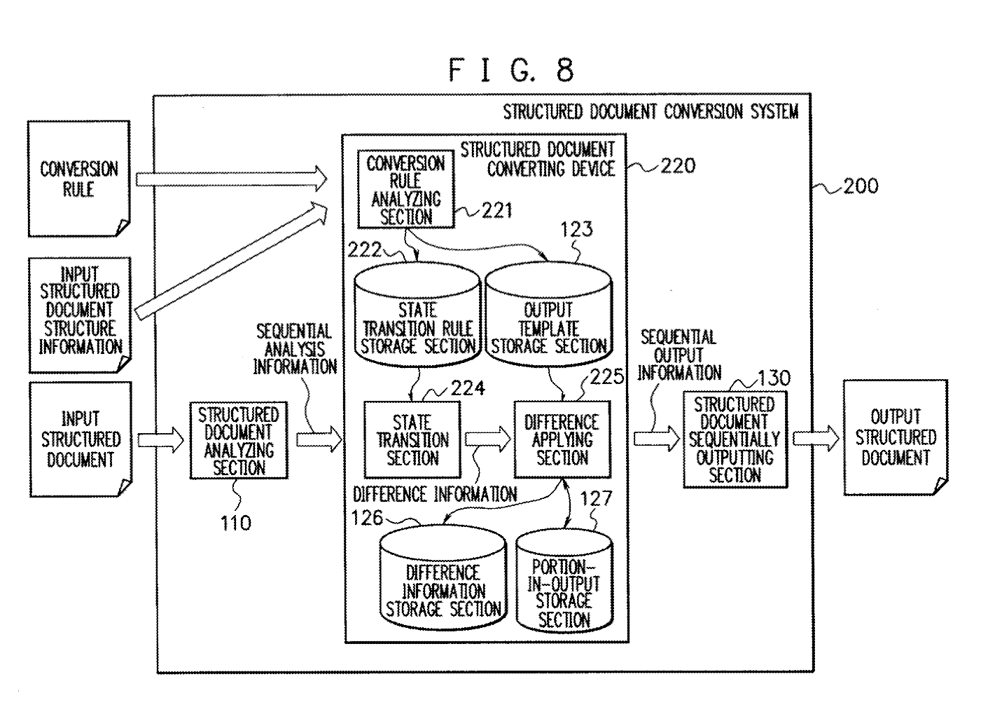

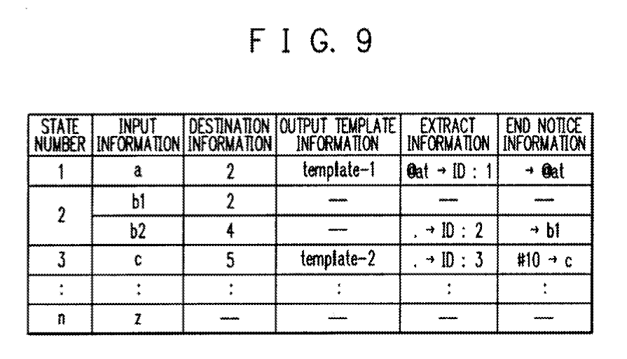

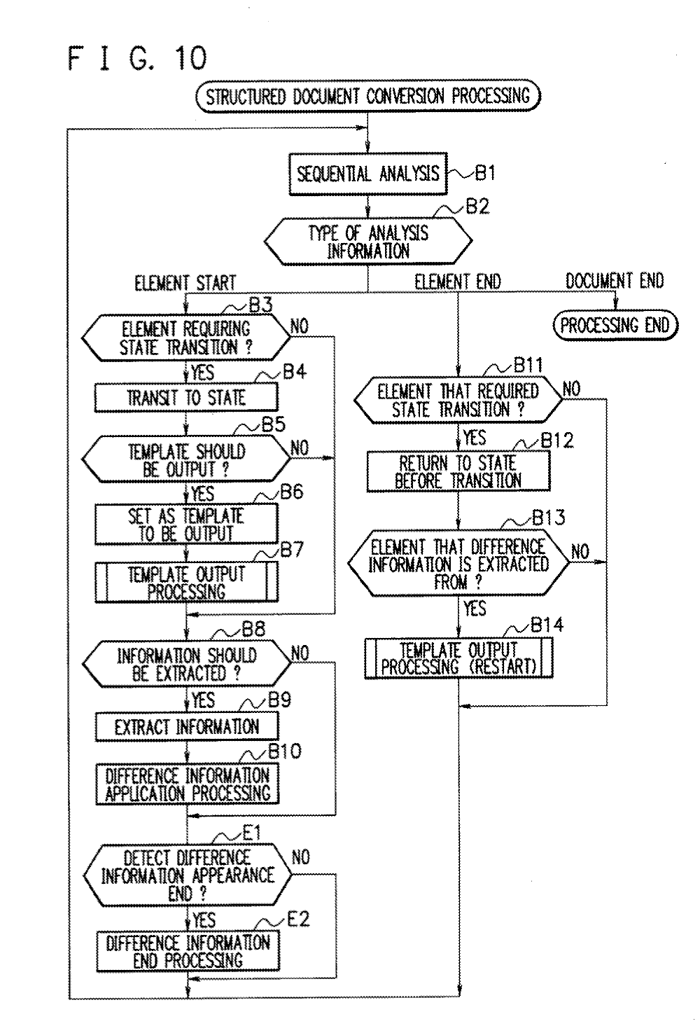

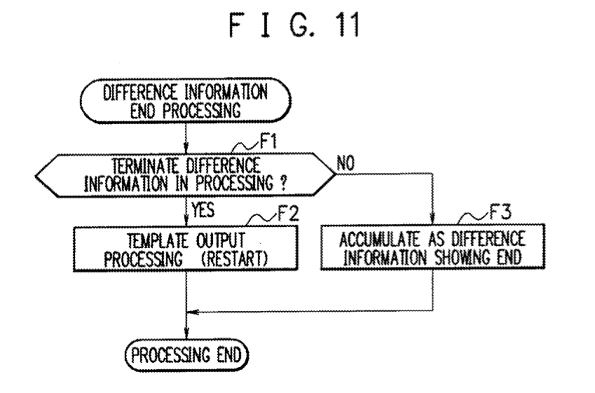

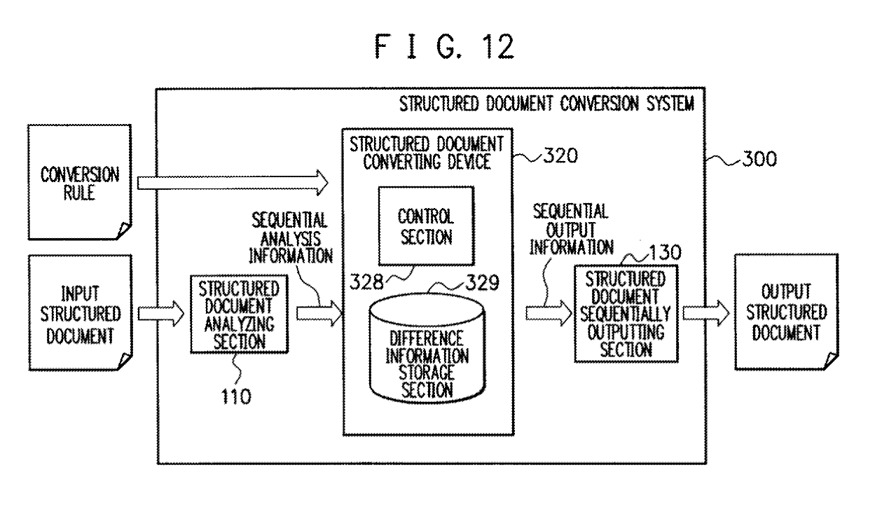

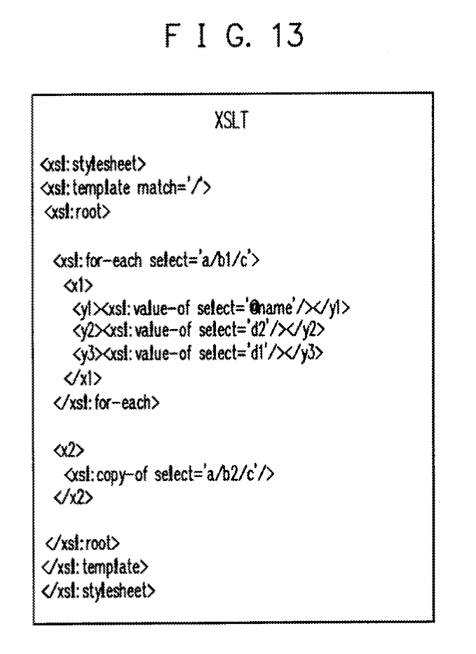

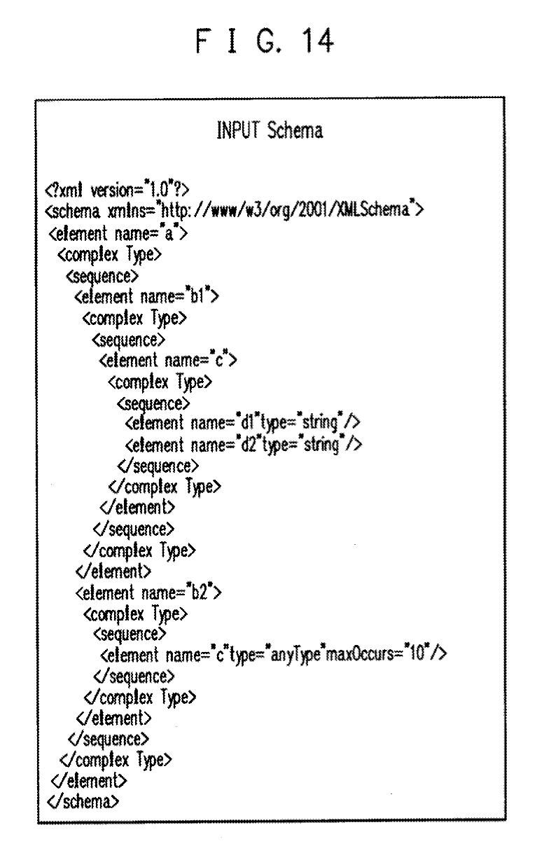

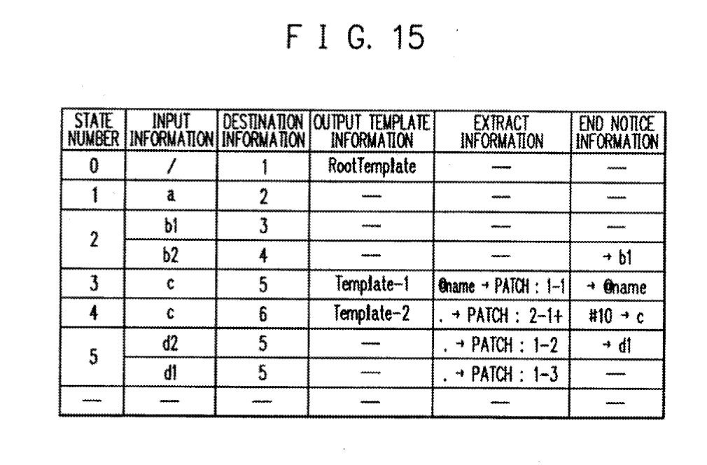

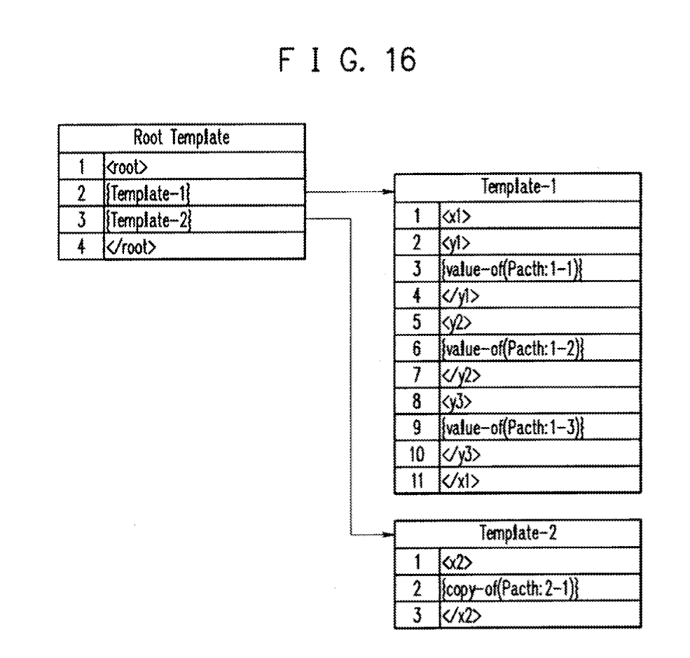

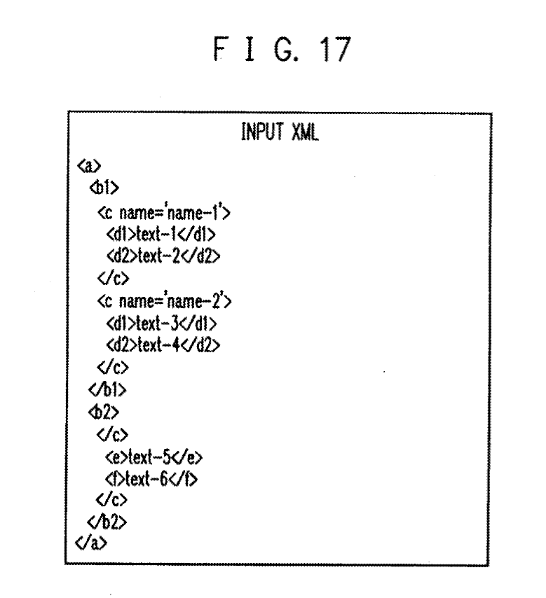

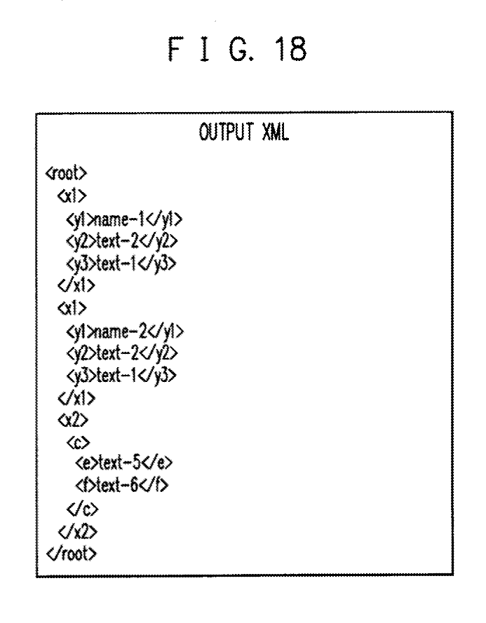

### DESCRIPTION OF REFERENCE NUMERALS

100, 200, 300 structured document conversion system
110 structured document analyzing section
120, 220, 320 structured document converting device
121, 221 conversion rule analyzing section
122, 222 state transition rule storage section
123 output model storage section
124, 224 state transition section
125, 225 difference applying section
126 difference information storage section
127 point-in-output storage section
130 structured documents sequentially outputting section

1-15. (canceled)

16. A structured document converting device for converting a document structure of a structured document, comprising:
a conversion rule analyzing section that generates a state transition rule that establishes analysis information of a sequential analysis result to an input structured document as an event to each state associating with a template of a converted structured document and a document structure of a pre-converted structured document according to a predetermined conversion rule, the state transition rule establishes a state of destination and information that is extracted as predetermined difference information to be applied to the template;
a state transition section that transits a state and extracts difference information 0 or more that should be extracted according to the state transition rule generated by the conversion rule analyzing section when receiving the analysis information showing the sequential analysis result to the pre-converted structured document;
a difference information storage section that accumulates difference information; and
a difference applying section that sequentially outputs information formed as a part of the converted structured document to the template by applying the difference information extracted by the state transition section or the difference information accumulated in the difference information storage section, wherein the difference applying section applies and outputs the difference information extracted by the state transition section when the difference information is applicable to a template immediately, and if not accumulates the difference information in the difference information storage section and waits for next difference information extraction.

17. The structured document converting device according to claim 16 wherein the conversion rule analyzing section divides the converted structured document every part structure to be grouped as an output unit and generates a template when the output unit forms a group,
the conversion rule analyzing section generates a state transition rule that establishes that when the state transits to a state corresponding to a first element of a part structure to be grouped as an output unit, the template corresponding to the part structure is output; and
the state transition section specifies a template to be outputted according to the state transition rule.

18. The structured document converting device according to claim 16, further comprising an output interruption point storage section that stores a point where the difference applying section interrupts an output and information showing difference information applied to the point, wherein
the difference applying section interrupts a sequential output and stores the interruption point and the information showing the difference information that should be applied to the point in the output interruption point storage section when the information formed as a part of the converted structured document cannot be obtained even if the difference information accumulated in the difference information storage section is applied to the template during the sequential output, and
the difference applying section determines whether the difference information can be applied to the template immediately based on an identifier of the difference information extracted by the state transition section and the information showing the difference information stored in the output interruption point storage section.

19. The structured document converting device according to claim 16, wherein the conversion rule analyzing section generates a state transition rule that establishes a condition for identifying an extraction end of difference information,
the state transition section detects the extraction end of the difference information according to the state transition rule, and
the difference applying section restarts the sequential output when the extraction end of the difference information that should be applied to the interruption point of the current output is detected by the state transition section.

20. The structured document converting device according to claim 19, wherein the conversion rule analyzing section generates a state transition rule that establishes a condition for identifying an extraction end of difference information based on the maximum appearance number of times of element or the appearance order of element shown as a rule of the document structure of the pre-converted structured document.

21. A structured document converting method for converting a document structure of a structured document, the method:
generates a state transition rule that establishes analysis information of a sequential analysis result to an input structured document as an event to each state associating with a template of a converted structured document and a document structure of a pre-converted structured document according to a predetermined conversion rule, the state transition rule establishes a state of destination and information that is extracted as predetermined difference information to be applied to the template;
transits a state and extracts difference information 0 or more that should be extracted according to the state transition rule generated by a conversion rule analyzing section when receiving the analysis information showing the sequential analysis result to the pre-converted structured document; and
in a course of outputting information formed as a part of the converted structured document to the template by applying the difference information extracted by a state transition section or difference information accumulated in a predetermined difference information storage section, the method applies and outputs the extracted difference information when the difference information is applicable to a template immediately, and if not accumulates the difference information in the difference information storage section and waits for next difference information extraction.

22. The structured document converting method according to claim 21, wherein the method divides the converted structured document every part structure to be grouped as an output unit and generates a template when the output unit forms a group and generates a state transition rule that establishes that when the state transits to a state corresponding to a first element of a part structure to be grouped as an output unit, the template corresponding to the part structure is output, and specifies a template to be outputted accompanying the state transition according to the state transition rule.

23. The structured document converting method according to claim 21, wherein the method interrupts a sequential output and stores an interruption point and information showing difference information that should be applied to the point in a predetermined output interruption point storage section when the information formed as a part of the converted structured document cannot be obtained even if the difference information accumulated in the difference information storage section is applied to the template and
when the difference information is extracted, the method determines whether the difference information can be applied to the template immediately based on an identifier of the extracted difference information and the information showing the difference information stored in the output interruption point storage section.

24. The structured document converting method according to claim 21, wherein the method generates a state transition rule that establishes a condition for identifying an extraction end of difference information,
detects the extraction end of the difference information accompanying the state transition according to the state transition rule, and
restarts the sequential output to the template when the extraction end of the difference information that should be applied to the interruption point of the current output is detected.

25. The structured document converting method according to claim 24, wherein the method generates a state transition rule that establishes a condition for identifying an extraction end of difference information based on the maximum appearance number of times of element or the appearance order of element shown as a rule of the document structure of the pre-converted structured document.

26. A storage medium for storing a structured document converting program for converting a document structure of a structured document, the program causes a computer to execute:
conversion rule analyzing processing for generating a state transition rule that establishes analysis information of a sequential analysis result to an input structured document as an event to each state associating with a template of a converted structured document and a document structure of a pre-converted structured document according to a predetermined conversion rule, the state transition rule establishes a state of destination and information that is extracted as predetermined difference information to be applied to the template;
state transition processing for transiting a state and extracting difference information 0 or more that should be extracted according to the state transition rule generated by a conversion rule analyzing section when receiving the analysis information showing the sequential analysis result to the pre-converted structured document; and
in a course of outputting information formed as a part of the converted structured document to the template by applying the difference information extracted by the state transition processing or difference information accumulated in a predetermined difference information storage section, difference applying processing for applying and outputting the extracted difference information when the difference information is applicable to a template immediately, and if not accumulating the difference information in the difference information storage section and waiting for next difference information extraction.

27. The storage medium for storing the structured document converting program according to claim 26, wherein the program causes the computer to, in the conversion rule analyzing processing, divide the converted structured document every part structure to be grouped as an output unit and generate a template when the output unit forms a group and generate a state transition rule that establishes that when the state transits to a state corresponding to a first element of a part structure to be grouped as an output unit, the template corresponding to the part structure is output, and
specify a template to be outputted according to the state transition rule in the state transition processing.

28. The storage medium for storing the structured document converting program according to claim 26, wherein the program causes the computer, in the difference applying processing, to interrupt a sequential output and store an interruption point and information showing difference information that should be applied to the point in a predetermined output interruption point storage section when the information formed as a part of the converted structured document cannot be obtained even if the difference information accumulated in the difference information storage section is applied to the template and
when the difference information is extracted, the program causes the computer to determine whether the difference information can be applied to the template immediately based on an identifier of the extracted difference information and the information showing the difference information stored in the output interruption point storage section.

29. The storage medium for storing the structured document converting program according to claim 26, wherein the program causes the computer to generate a state transition rule that establishes a condition for identifying an extraction end of difference information in the conversion rule analyzing processing, detect the extraction end of the difference information according to the state transition rule in the state transition processing, and
restart the sequential output to the template when the extraction end of the difference information that should be applied to the interruption point of the current output is detected in the difference applying processing.

30. The storage medium for storing the structured document converting program according to of claim 29, wherein the program causes the computer to generate a state transition rule that establishes a condition for identifying an extraction end of difference information based on the maximum appearance number of times of element or the appearance order of element shown as a rule of the document structure of the pre-converted structured document in the conversion rule analyzing processing.
